(19) United States
(12) Patent Application Publication
(10) Pub. No.: US 2024/0030448 A1
(43) Pub. Date: Jan. 25, 2024

(54) CONDUCTIVE MATERIAL DISPERSION, AND METHODS FOR MANUFACTURING POSITIVE ELECTRODE FOR LITHIUM ION SECONDARY BATTERY AND LITHIUM ION SECONDARY BATTERY USING SAME

(71) Applicant: MIKUNI SHIKISO KABUSHIKI KAISHA, Himeji-shi (JP)

(72) Inventor: Rie KAJIHARA, Himeji-shi (JP)

(73) Assignee: MIKUNI SHIKISO KABUSHIKI KAISHA, Himeji-shi (JP)

(21) Appl. No.: 17/905,954

(22) PCT Filed: Mar. 6, 2021
(86) PCT No.: PCT/JP2021/008845

§ 371 Date: Feb. 28, 2023

(30) Foreign Application Priority Data
Mar. 9, 2020 (JP) 2020-039799

(51) Int. Cl. H01M 4/62; H01M 4/04; H01M 10/0525

(52) U.S. Cl. CPC H01M 4/625; H01M 4/622; H01M 4/04; H01M 10/0525; H01M 2004/028

(57) ABSTRACT

An object of the present application is to provide a conductive material dispersion having excellent performance, and methods for manufacturing a positive electrode for a lithium ion secondary battery and a lithium ion secondary battery, using the conductive material dispersion. As a means for achieving the object, the conductive material dispersion contains at least a conductive material, a dispersion medium, a polyvinyl acetal-based resin, and a cellulose-based resin, wherein 10-200 parts by weight of the polyvinyl acetal-based resin is contained with respect to 100 parts by weight of the cellulose-based resin.

### TECHNICAL FIELD

The present invention provides a conductive material dispersion, which has excellent dispersibility and conductivity, can maintain an appropriate quality for a long period, and is suitable as a material of an electrode paste used in making electrodes, and methods for manufacturing a positive electrode for a lithium ion secondary battery and a lithium ion secondary battery using such a conductive material dispersion.

### TECHNICAL BACKGROUND

Lithium ion secondary batteries have the highest energy density among batteries in practical use, and are increasingly being used in portable electronic devices such as smartphones and in automobiles. In this situation, in addition to miniaturization, weight reduction, and a long life, higher performance such as operation in a wide temperature range and improved safety are demanded for the lithium ion secondary batteries.

A lithium ion secondary battery is generally formed of electrodes, a separator, and an electrolyte solution containing an electrolyte. Further, for the electrodes, a positive electrode obtained by applying and adhering an electrode paste, which contains a positive electrode active material containing lithium ions, a conductive material, an organic binder, and the like, to a surface of a current collector metal foil, and a negative electrode obtained by adhering an electrode paste, which contains a negative electrode active material capable of inserting and releasing lithium ions, a conductive material, an organic binder, and the like, to a surface of a current collector metal foil are used.

In particular, for a positive electrode, a composite oxide of a transition metal (such as LiCoO₂) and lithium, which is used as a positive electrode active material, has a low electronic conductivity, and, when used alone, sufficient battery performance cannot be obtained. Therefore, attempts have been made to lower an internal resistance of a battery and bring out original battery performance by using a carbon material such as carbon black or carbon nanotubes as a conductive material.

In order to lower an internal resistance of a battery, it is necessary to form a good conductive path between a current collector and an active material, and between active materials. For this purpose, it is preferable to use a conductive material exhibiting a high conductivity, such as carbon black, which has a small particle size and a high structure, or carbon nanotubes, which have small outer diameters and are long. However, such a conductive material has a strong cohesive force and thus tends to be non-uniform, and sufficient performance cannot be obtained as it is. Therefore, a method is known in which a conductive material dispersion obtained by dispersing a conductive material in an optimal state in advance is used, and use of a dispersant has been proposed to more uniformly disperse a conductive material and to suppress an increase in viscosity (Patent Documents 1 and 2).

### RELATED ART

### Patent Documents

### Patent Document 1: Japanese Patent No. 5628503.

### Patent Document 2: Japanese Patent Application Laid-Open Publication No. 2011-184664.

### SUMMARY OF THE INVENTION

### Problems to be Solved by the Invention

However, it has been found that, in the method described in Patent Document 1, the effect of suppressing an increase in viscosity is still insufficient. In particular, when the concentration of the conductive material is high, the viscosity of the conductive material dispersion increases significantly, resulting in a poor handleability. Further, the storage stability of the conductive material dispersion is also insufficient and the viscosity increases with time. When using such a conductive material dispersion to prepare an electrode paste by blending an active material with a binder and any additive, not only there is a variation in kneading condition and productivity drops, but there is also a possibility that a stable quality cannot be ensured due to that there are places where a coating amount of the conductive material with respect to the active material is out of balance.

To avoid this problem, it is possible to use a low-concentration conductive material dispersion, but in this case, an amount of a solvent used increases and a load in a drying process increases. In addition, flexibility in designing an electrode composition is reduced in order to keep an electrode paste within an appropriate viscosity range, which may become a hindrance to development of higher performance.

### Means for Solving the Problems

As a result of intensive studies to solve the above problem, the present inventor has found that, by combining specific resins, the viscosity can be kept low even at a high concentration and the storage stability is also excellent, and thus has accomplished the present invention.

That is, the present invention provides a conductive material dispersion that has excellent storage stability, can contain a conductive material at a high concentration, and is suitable for a positive electrode of a lithium ion secondary battery, and provides methods for manufacturing a lithium ion secondary battery and a positive electrode for a lithium ion secondary battery using such a conductive material dispersion.

### Effect of Invention

According to the present invention, by using a conductive material dispersion obtained by dispersing a conductive material in a dispersion medium at a high concentration, a kneading time during electrode paste manufacturing can be shortened and in-plane variation of a finished positive electrode can be suppressed, and thus, a lithium ion secondary battery with a stable quality can be provided. Further, according to the present invention, since a solid content of an electrode paste can be increased, not only a drying process time can be shortened, but also an absolute amount of a solvent used can be reduced, and thus, a burden of regenerating the solvent is also reduced. That is, an environmental impact can be reduced.

### MODE FOR CARRYING OUT THE INVENTION

That is, the present invention includes the following.

(1) A conductive material dispersion containing at least a conductive material, a dispersion medium, a polyvinyl acetal-based resin and a cellulose-based resin, wherein 10-200 parts by weight of the polyvinyl acetal-based resin is contained with respect to 100 parts by weight of the cellulose-based resin.

(2) The conductive material dispersion according to the above (1), wherein the conductive material is carbon black having a primary particle size of 30 nm or less and a DBP oil absorption of 160-250 ml/(100 g).

(3) The conductive material dispersion according to the above (1) or (2), wherein the polyvinyl acetal-based resin has an average polymerization degree of 100-600.

(4) The conductive material dispersion according to any one of the above (1)-(3), wherein the cellulose-based resin has a weight average molecular weight of 5,000-50,000.

(5) A method for manufacturing a positive electrode for a lithium ion secondary battery, comprising: mixing the conductive material dispersion according to the above (1), (2), (3) or (4), an electrode active material, and a binder; applying the mixture to an electrode substrate; and drying the mixture.

(6) A method for manufacturing a lithium ion secondary battery comprising: mixing the conductive material dispersion according to the above (1), (2), (3) or (4), an electrode active material, and a binder; applying the mixture to an electrode substrate; drying the mixture; and incorporating the resulting product as a positive electrode.

### [Conductive Material Dispersion]

The conductive material dispersion of the present invention contains at least a dispersion medium, a conductive material, a polyvinyl acetal-based resin, and, a cellulose-based resin.

### <Dispersion Medium>

The dispersion medium used in the present invention is not particularly limited. However, since polyvinylidene fluoride is generally used as a binder for batteries, it needs to be dissolved. Therefore, in general, N-methyl-2-pyrrolidone is suitable. As long as the binder can be uniformly dissolved, there is no problem even when other ingredients are mixed.

### <Polyvinyl Acetal-Based Resin>

The conductive material dispersion of the present invention contains a polyvinyl acetal-based resin.

The polyvinyl acetal-based resin is a resin generally obtained by acetalizing a polyvinyl alcohol-based resin (abbreviated as PVA) by dehydration condensation with aldehyde, and is a polymer compound having at least three types of repeating units: a unit containing an acetal group (an acetalized vinyl alcohol unit of PVA), a unit containing a hydroxyl group (derived from a vinyl alcohol unit of PVA), and a unit containing an acetyl group (derived from an unsaponified portion during PVA manufacturing). Therefore, it is typically represented by the following formula (Formula 1).

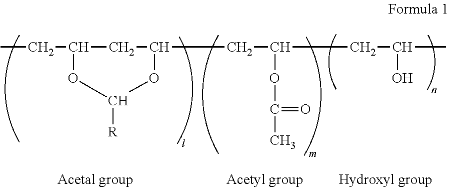

The polyvinyl acetal-based resin used in the present invention is not particularly limited, and various commercially available products can each be used alone or two or more of the commercially available products can be used in combination. Also, the acetal group is not particularly limited, and various polyvinyl acetal-based resins synthesized using commonly known methods can be used. Examples thereof include a polyvinyl butyral resin in which R is a butyl group, a polyvinyl acetoacetal resin in which R is an acetyl group, and the like.

In Formula 1, preferably, 1 is 50-90 mol %, m is 0-10 mol %, and n is 10-50 mol %. Particularly preferably, 1 is 50-80 mol %, m is 0-5 mol % and n is 15-40 mol %.

Examples of the commercially available products include S-LEC B BL-1, S-LEC B BL-10, S-LEC B BL-S, S-LEC B BX-L, S-LEC K KS-10 (the above are product names, manufactured by Sekisui Chemical Co., Ltd.), Mowital B14S, Mowital B16H, Mowital B20H, Mowital B30T, Mowital B30H, Mowital B30HH, Mowital B45M, Mowital B45H, Mowital B60T, Mowital B60H, Mowital B60HH, Mowital 75H (the above are product names, manufactured by Kuraray Co., Ltd.), and the like.

Among these, in particular, there is a polyvinyl acetal resin having an average polymerization degree of 100-600, preferably 150-600, and more preferably 200-500. The average polymerization degree can be measured according to JIS K6726.

From these, according to a solvent, one that dissolves well may be selected. When N-methyl-2-pyrrolidone is used, S-LEC BL-1, S-LEC BL-10, S-LEC BX-L, Mowital B14S, Mowital B16H, and Mowital B20H are suitable.

### <Cellulose-Based Resin>

The conductive material dispersion of the present invention contains a cellulose-based resin.

The cellulose-based resin used in the present invention is not particularly limited as long as the cellulose-based resin is a polymer having a cellulose skeleton. Specific examples thereof include alcohol-soluble butyrate of cellulose, cellulose acetate, cellulose acetate butyrate, cellulose butyrate, cyanoethyl cellulose, methyl cellulose, ethyl cellulose, hydroxyethyl cellulose, ethyl hydroxyethyl cellulose, nitrocellulose, carboxymethyl cellulose, carboxymethylcellulose sodium, carboxymethylcellulose ammonium, hydroxyethyl cellulose, hydroxypropyl cellulose, Hydroxypropyl methylcellulose, and the like.

Among these, in particular, there is a cellulose resin, which is a polymer having a weight average molecular weight of 5,000-200,000, and which preferably has a weight average molecular weight of 5,000-100,000, and even more preferably has a weight average molecular weight of 5,000-50,000.

From these, according to a solvent, one that dissolves well may be selected. When N-methyl-2-pyrrolidone is used, cellulose acetate, cellulose acetate butyrate, methyl cellulose, ethyl cellulose, hydroxyethyl cellulose, ethyl hydroxyethyl cellulose, hydroxyethyl cellulose, hydroxypropyl cellulose, and hydroxypropyl methylcellulose are suitable. Further, from a point of view of having excellent resistance to an electrolyte solution, cellulose acetate and methyl cellulose are good, and from a point of view of having all of these, methyl cellulose is most preferable.

### <Additive Amount and Mixing Ratio of Polyvinyl Acetal-Based Resin and Cellulose-Based Resin>

A total amount of the polyvinyl acetal-based resin and the cellulose-based resin in the conductive material dispersion is preferably 3-30 parts by weight, more preferably 5-20 parts by weight, and even more preferably 6-15 parts by weight with respect to 100 parts by weight of the conductive material.

When the content of the polyvinyl acetal-based resin and the cellulose-based resin is too low, agglomerates of the conductive material are not sufficiently dissolved and a non-uniform state remains, and conductivity of a coating film produced using an electrode paste obtained by blending such a conductive material dispersion with an active material or an organic binder tends to decrease. When the content of the polyvinyl acetal-based resin and the cellulose-based resin in the conductive material dispersion is too high, a resistance component in a coating film produced using an electrode paste obtained using this conductive material dispersion increases, and thus, the conductivity decreases, and when a lithium ion secondary battery having a positive electrode formed of such a coating film is constructed, it may be difficult to achieve a high capacity.

Further, in the present invention, the polyvinyl acetal-based resin and the cellulose-based resin described above are contained at a certain ratio. That is, it is characterized by that 10-200 parts by weight of the polyvinyl acetal-based resin is contained with respect to 100 parts by weight of the cellulose-based resin.

With this ratio, a uniform conductive material dispersion with good stability can be obtained, and the effect of lowering the viscosity and improving the stability of the conductive material dispersion is excellent. It is more preferably 10-150 parts by weight and even more preferably 25-100 parts by weight with respect to 100 parts by weight of the cellulose-based resin.

### <Conductive Material>

As the conductive material used in the present invention, carbon black and carbon nanotubes, carbon nanofibers, graphite, graphene, hard carbon, and the like are suitable. As carbon black, ketjen black, furnace black, acetylene black, thermal black, and the like can be used. Further, these conductive materials can each be used alone, or two or more of these conductive materials may be used in combination.

An average primary particle size of the carbon black is preferably 50 nm or less, particularly preferably 40 nm or less, and more preferably 30 nm or less. Further, the average primary particle size is preferably 10 nm or more, and particularly preferably 15 nm or more. When the average primary particle size of the carbon black is too large, conductivity of a coating film obtained from the electrode paste tends to decrease. On the other hand, when it is too small, it may be possible that the conductive material dispersion and the electrode paste are too viscous, dispersion of the carbon black becomes difficult, and sufficient conductivity cannot be achieved.

The average primary particle size indicates an arithmetic mean particle size measured using a transmission electron microscope according to ASTM: D3849-14. The average primary particle size is generally used for evaluating a physical property of a conductive material.

DBP oil absorption of the carbon black is preferably 160-250 ml/(100 g), more preferably 170-240 ml/(100 g), and most preferably 170-230 ml/(100 g). When the DBP oil absorption of the carbon black is too small, connections between carbon black particles are short and conductivity is poor. Further, when it is too large, it may be possible that the conductive material dispersion and the electrode paste are too viscous, dispersion of the carbon black becomes difficult, and sufficient conductivity cannot be achieved.

The DBP oil absorption may be measured according to JIS6217-4. Further, the DBP oil absorption reflects a degree of development of an aggregate, which is a state called a structure in which carbon black particles are fused together, and thus, is used as an indicator of conductivity.

A dispersion particle size of the carbon black in the dispersion is preferably 40 μm or less, more preferably 30 μm or less, and even more preferably 20 μm or less, as a maximum particle size. In general, an average particle size is used in management of a particle state of a dispersion of a conductive material or the like. However, when an average particle size is used, since existence of coarse particles is not taken into consideration, even when the average particle size has a small value, coarse particles exceeding 40 μm in maximum particle size may actually exist. In this case, there is a possibility that distribution of an active material and a conductive material in an electrode coating film of a lithium ion secondary battery becomes non-uniform, and battery performance is impaired.

The maximum particle size may be measured using a grind gauge in accordance with JIS K5600-2-5.

Purity of the carbon black is preferably 99.90-100% by mass, and more preferably 99.95-100% by mass. The purity of the carbon black can be calculated based on an amount of impurities, with ash measured according to JIS K1469 or JIS K6218 as the impurities.

An example of carbon black having these features is acetylene black, and specific examples include Denka Black Powder, Denka Black Granules, Denka Black FX-35, Denka Black HS-100, Denka Black Li Li-100, Denka Black Li Li-250, Denka Black Li Li-400, Denka Black Li Li-435, and the like (the above are product names, manufactured by Denka Co., Ltd.). Among these, Denka Black FX-35 and Denka Black Li Li-435 are particularly suitable.

The carbon nanotubes are carbon crystals each having a substantially tubular shape. An average outer diameter of the carbon nanotubes is preferably 90 nm or less, particularly preferably 30 nm or less, more preferably 20 nm or less, and most preferably 15 nm or less. Further, the average outer diameter is preferably 1 nm or more, or 5 nm or more. When the average outer diameter of the carbon nanotubes is too large, conductivity of a coating film obtained from the electrode paste tends to decrease. On the other hand, when it is too small, it may be possible that the conductive material dispersion and the electrode paste are too viscous, and dispersion of the carbon nanotubes becomes difficult.

The average outer diameter of the carbon nanotubes is an arithmetic mean value of a sufficient number (n) of outer diameters measured using transmission electron microscope images at a magnification of 100,000× or more.

Specific examples of the carbon nanotubes include VGCF-X (average outer diameter: 30 nm) manufactured by Showa Denko Co., Ltd., C100 (average outer diameter: 10-15 nm) and U100 (average outer diameter: 10-15 nm, high purity product) manufactured by ARKEMA, NC7000 (average outer diameter: 10 nm), NC2150, and NC3100 manufactured by Nanocyl, Baytubes C150 (average outer diameter: 13-16 nm), and BaytubesC150P (average outer diameter 13-16 nm) manufactured by BAYER, MWNT (average outer diameter: 40-90 nm) manufactured by Hodogaya Chemical Co., Ltd., and the like. Further, it is possible to use one type of carbon nanotubes alone or two or more types of carbon nanotubes in combination.

When the conductive material dispersion of the present disclosure contains carbon nanotubes, it is preferable that the carbon nanotubes are dispersed individually one by one without agglomeration. This is because a coating film obtained from the electrode paste is excellent in conductivity.

Multiple types of conductive materials such as carbon black and carbon nanotubes may be used in combination.

An amount of the conductive material contained in the conductive material dispersion is suitably 10-30 wt %, preferably 12-25 wt %, and more preferably 13-22 wt %.

When the content of the conductive material in the conductive material dispersion is too low, when the electrode paste is prepared, a total solid content is reduced and the viscosity is lower than desired, resulting in a nonuniform coating film with unevenness. A nonuniform coating film refers to a coating film in a state in which an active material and a conductive material are unevenly distributed, or a coating film in a state in which a basis weight (coating amount on a current collector) varies depending on a location. When a lithium ion secondary battery having, on a positive electrode, a coating film in a state in which an active material and a conductive material are unevenly distributed is constructed, there is a possibility that performance such as high-speed charging and discharging or durability may be impaired due to reduced conductivity or unevenly distributed charges. When multiple lithium ion secondary batteries are manufactured using a coating film in a state in which a basis weight varies depending on a location, a capacity of each of the lithium ion secondary batteries varies, which may result in a poor yield. When the content of the conductive material in the conductive material dispersion is too high, flowability of the conductive material dispersion may decrease, and handling may become difficult during electrode paste preparation.

### <Optional Ingredients>

The conductive material dispersion of the present invention may contain, as appropriate, optional ingredients other than the conductive material, the cellulose-based resin, the polyvinyl acetal-based resin, and the dispersion medium, within the scope of the present invention. Examples of such optional ingredients include: a dispersant (referring to an ingredient that is other than the cellulose-based resin and the polyvinyl acetal-based resin described above and has a function of dispersing the conductive material); a phosphorus compound; a sulfur compound; an organic acid; a nitrogen compound such as an amine compound or an ammonium compound; an organic ester; and conventionally known additives such as various silane-based, titanium-based and aluminum-based coupling agents. Further, these optional ingredients can each be used alone, or two or more of these optional ingredients may be used in combination.

Examples of the dispersant include polyvinylidene fluoride, polytetrafluoroethylene, polyhexafluoropropylene, polyethylene, polypropylene, polymethyl methacrylate, polyvinyl chloride, polyvinylidene chloride, polyvinyl acetate, polyacrylic acid, polyvinyl butyral, polyacrylamide, polyurethane, polydimethylsiloxane, an epoxy resin, an acrylic resin, a polyester resin, a melamine resin, a phenolic resin, various rubbers, lignin, pectin, gelatin, xanthan gum, wellangum, succinoglycan, polyvinyl alcohol, polyalkylene oxide, polyvinyl ether, polyvinylpyrrolidone, chitins, chitosans, and nonionic dispersants such as starch.

A blending amount of the dispersant is preferably 0.1-100 parts by mass, and more preferably 0.1-50 parts by mass, with respect to 100 parts by mass of the conductive material.

Examples of the phosphorus compound include tributylphosphine, triphenylphosphine, triethyl phosphite, triphenyl phosphite, and the like.

Examples of the sulfur compound include butanethiol, n-hexanethiol, diethyl sulfide, tetrahydrothiopene, and the like.

Examples of the organic acid include acetic acid, propionic acid, butyric acid, caproic acid, acrylic acid, crotonic acid, capric acid, stearic acid, oleic acid, oxalic acid, succinic acid, adipic acid, maleic acid, glutaric acid, benzoic acid, 2-methylbenzoic acid, 4-methylbenzoic acid, a mixture of two or more of these, and the like.

Examples of the amine compound include methylamine, ethylamine, n-propylamine, n-butylamine, n-hexylamine, n-heptylamine, 2-ethylhexylamine, n-octylamine, nonylamine, decylamine, dodecylamine, docodecylamine, hexadecylamine, octadecylamine, isopropylamine, isobutylamine, isooctylamine, isoamylamine, allylamine, cyanoethylamine, cyclopropylamine, cyclohexylamine, cyclopentylamine, aniline, N,N-dimethylaniline, benzylamine, anisidine, aminobenzonitrile, piperidine, pyrazine, pyridine, pyrrole, pyrrolidine, methoxyamine, methoxyethylamine, methoxyethoxyethylamine, methoxyethoxyethoxyethylamine, methoxypropylamine, ethoxyamine, n-butoxyamine, 2-hexyloxyamine, 2-amino-2-methyl-1-propanol, aminoacetaldehyde dimethylacetal, hydroxylamine, ethanolamine, diethanolamine, methyldiethanolamine, 2-hydroxypropylamine, N-ethyldiethanolamine, N-methyldiethanolamine, aminoethylethanolamine, dimethylethanolamine, triisopropanolamine, triethanolamine, ethylenediamine, propylenediamine, tritriethylenediamine, triethylenetetramine, hexamethylenediamine, 2-ethyldiamine, 2,2-(ethylenedioxy) bisethylamine, tetramethylpropylenediamine, morpholine, N-methylmorpholine, N-ethylmorpholine, N-methylpiperidine, dimethylamine, diethylamine, dipropylamine, diethylenetriamine, tri-n-butylamine, ammonium hydroxide, imidazole, diazabicycloundecene, diazabicyclooctane, taurine, hydrazine, hexamethyleneimine, polyallylamine, polyethylenimine, adipic dihydrazide, and the like.

Examples of the ammonium compound include 2-ethylhexylammonium 2-ethylhexylcarbamate, 2-ethylhexylammonium 2-ethylhexyl carbonate, 2-cyanoethylammonium 2-cyanoethylcarbamate, 2-cyanoethyl ammonium 2-cyanoethyl carbonate, 2-methoxyethylammonium 2-methoxyethylcarbamate, 2-methoxyethyl ammonium 2-methoxyethyl carbonate, n-butylammonium n-butylcarbamate, n-butylammonium n-butyl carbonate, t-butylammonium t-butylcarbamate, t-butylammonium t-butyl carbonate, isobutylammonium isobutylcarbamate, isobutylammonium isobutyl carbonate, isopropylammonium isopropylcarbamate, triethylenediamine isopropylcarbamate, isopropylammonium isopropyl carbonate, triethylenediamine isopropyl carbonate, ethylammonium ethylcarbamate, pyridinium ethylhexylcarbamate, ethylammonium ethyl carbonate, octadecyl ammonium octadecyl carbamate, octadecyl ammonium octadecyl carbonate, ammonium carbamate, dioctadecyl ammonium dioctadecylcarbamate, dioctadecyl ammonium dioctadecyl carbonate, dibutylammonium dibutylcarbamate, dibutylammonium dibutyl carbonate, triethoxysilylpropylammonium triethoxysilylpropylcarbamate, triethoxysilylpropyl ammonium carbonate, hexamethyleneiminium hexamethyleneimine carbamate, hexamethyleneiminium ammonium hexamethyleneimine carbonate, benzylammonium benzylcarbamate, benzylammonium benzyl carbonate, methyl decyl ammonium methyl decyl carbamate, methyl decyl ammonium methyl decyl carbonate, morpholinium morpholine carbamate, morpholium morpholine carbonate, 2-ethylhexylammonium bicarbonate, 2-cyanoethylammonium bicarbonate, 2-methoxyethylammonium bicarbonate, t-butylammonium bicarbonate, ammonium bicarbonate, isopropylammonium bicarbonate, dioctadecyl ammonium bicarbonate, triethylenediamine bicarbonate, pyridinium bicarbonate, and the like, and derivatives or mixtures of these, and the like.

Examples of the organic ester include ethyl acetate, isobutyl acetate, n-butyl acetate, methyl propionate, ethyl propionate, methyl butyrate, methyl acrylate, dimethyl oxalate, dimethyl succinate, methyl crotonate, methyl benzoate, methyl 2-methylbenzoate, mixtures of these, and the like.

Examples of the silane coupling agent include vinyltrimethoxysilane, γ-methacryloxypropyl-tris((3-methoxyethoxy)silane, β-(3,4-epoxycyclohexyl) ethyltrimethoxysilane, γ-glycidoxypropyltrimethoxysilane, vinyltriacetoxysilane, γ-mercaptopropyltrimethoxysilane, γ-methacryloxypropyltrimethoxysilane, γ-aminopropyltriethoxysilane, N-β-(aminoethyl)-γ-aminopropyltrimethoxysilane, N-β-(aminoethyl)-γ-aminopropylmethylmethoxysilane, N-β-(aminoethyl)-γ-aminopropylmethyldimethoxysilane, N,N-bis(β-hydroxyethyl)-γ-aminopropyltriethoxysilane, γ-chloropropyltrimethoxysilane, vinyltris (2-methoxyethoxysilane), 2-(3,4-epoxycyclohexyl) ethyltrimethoxysilane, N-phenyl-γ-aminopropyltrimethoxysilane, γ-chloropropyltrimethoxysilane, and the like.

Examples of the titanium coupling agent include tetrabutyl titanate, tetraoctyl titanate, isopropyl triisostearoyl titanate, Isopropyltridecylbenzenesulfonyl titanate, bis(dioctylpyrophosphate) oxyacetate titanate, trimethoxy titanate, tetramethoxy titanate, triethoxy titanate, tetraethoxy titanate, tetrapropoxy titanate, chlorotrimethoxytitanate, chlorotriethoxy titanate, ethyltrimethoxytitanate, methyl triethoxy titanate, ethyl triethoxy titanate, diethyl diethoxy titanate, phenyltrimethoxytitanate, phenyltriethoxytitanate, mixtures of these, and the like.

Examples of the aluminum-based coupling agent include various aluminum chelates, alkyl acetoacetate aluminum diisopropylate, aluminum bisethyl acetate diisopropylate, acetoalkodisialuminum diisopropylate, mixtures of these, and the like.

### <Viscosity of Dispersion>

The viscosity of the conductive material dispersion of the present invention is preferably 50-5,000 mPa·s, more preferably 80-3,000 mPa·s, and even more preferably 80-2,000 mPa·s. When the viscosity of the dispersion is less than 50 mPa·s, it is difficult to suppress sedimentation of the conductive material in the dispersion, and thus it becomes difficult to maintain the quality over a long period of time. Further, the viscosity of the electrode paste prepared by mixing the active material, the binder and the conductive material dispersion is below an optimum range, and thus it becomes difficult to form a uniform coating film with a desired thickness. On the other hand, when the viscosity of the dispersion exceeds 5,000 mPa·s, the viscosity of the electrode paste also increases, and thus, kneading and coating become difficult.

The viscosity of the conductive material dispersion can be measured using a B-type viscometer according to JIS K7117-1.

### <Method for Producing Conductive Material Dispersion>

A method for producing the conductive material dispersion of the present invention is not limited as long as the dispersion contains the ingredients described above in predetermined blending ratios and has a desired viscosity. However, the following method is preferable.

First, the polyvinyl acetal-based resin and the cellulose-based resin are dissolved in a dispersion medium (preferably N-methyl-2-pyrrolidone). To the solution, the optional ingredients, when necessary, and the conductive material are mixed, and after that, a general dispersing device such as a bead mill is used to crush and disperse agglomerated conductive material, and the dispersing is continued until a desired viscosity is achieved. In this way, a dispersion containing the conductive material having predetermined dispersion particle size and viscosity at a predetermined concentration can be obtained.

The dispersing device is preferably a device capable of dispersing to a maximum particle size of 20 μm or less, but it is not limited to a bead mill, and examples thereof include a ball mill, a jet mill, and the like.

### [Use of Conductive Material Dispersion for Lithium Ion Secondary Battery]

As a method of using the conductive material dispersion of the present invention, a lithium ion secondary battery can be obtained by preparing an electrode paste for being applied to an electrode substrate by mixing the conductive material dispersion of the present invention, with a positive electrode active material, a binder, and the like. As the method, various conventionally known methods can be adopted. As a representative example, the conductive material dispersion of the present invention is mixed with a positive electrode active material and a binder to form a slurry, which is applied to an electrode substrate and dried to form an electrode. This electrode is used as a positive electrode of a lithium ion secondary battery, and a separator formed of a porous insulating material is sandwiched between this positive electrode and a negative electrode formed of a carbon material such as graphite, and these are rolled into a cylindrical shape or a flat shape according to a shape of a container and are accommodated therein, and an electrolyte solution is injected thereto. A lithium ion secondary battery of the present invention thus obtained can maintain its performance even after repeated charging and discharging over a long period of time.

### EXAMPLES

In the following, the present invention is described in detail based on examples. However, the present invention is not limited to these examples.

The carbon black, the polyvinyl acetal-based resin, the cellulose-based resin, the active material, and the binder used in Examples and Comparative Examples are described below.

### <Carbon Black>

Denka Black Li Li-435 (product name, manufactured by Denka Co., Ltd.): acetylene black, primary particle size: 23 nm, DBP oil absorption: 220 ml/(100 g), hereinafter abbreviated as Li-435.

### <Polyvinyl Acetal-Based Resin>

S-LEC B BL-1 (product name, manufactured by Sekisui Chemical Co., Ltd.): polyvinyl butyral resin, average polymerization degree: 300, hydroxyl group amount: 36 mol %, butyralization degree: 63 mol %, hereinafter abbreviated as BL-1.
S-LEC B BL-10 (product name, manufactured by Sekisui Chemical Co., Ltd.): polyvinyl butyral resin, average polymerization degree: 250, hydroxyl group amount: 28 mol %, butyralization degree: 71 mol %, hereinafter abbreviated as BL-10.
S-LEC B BX-L (product name, manufactured by Sekisui Chemical Co., Ltd.): polyvinyl acetal resin, average polymerization degree: 250, hydroxyl group amount: 32 mol %, acetalization degree: 67 mol %, hereinafter abbreviated as BX-L.
Mowital B16H (product name, manufactured by Kuraray Co., Ltd.): polyvinyl butyral resin, average polymerization degree: 250-300, hydroxyl group amount: 26-30 mol %, butyralization degree: 70-73 mol %, hereinafter abbreviated as B16H.
Mowital B20H (product name, manufactured by Kuraray Co., Ltd.): polyvinyl butyral resin, average polymerization degree: 250-500, hydroxyl group amount: 26-30 mol %, butyralization degree: 70-73 mol %, hereinafter abbreviated as B20H.

### <Cellulose Resin>

Methyl cellulose: weight average molecular weight: 35,000-45,000, methoxy group substitution degree: 1.8, hereinafter abbreviated as MC. The weight average molecular weight can be measured using gel filtration chromatography. An example of measurement conditions for gel filtration chromatography is described below.

Device: Prominence (manufactured by Shimadzu Corporation)

Column: OHpakSB-802.5HQ (manufactured by Shodex Co., Ltd.),

OHpakSB-804HQ (manufactured by Shodex Co., Ltd.)

Detection: RI

Eluent: 0.5 M NaCl aqueous solution

Flow rate: 1.0 ml/min

Sample concentration: 0.2 wt/vol %

Column temperature: 40° C.

### <Active Material>

Cellseed C-5H (product name, manufactured by Nippon Kagaku Kogyo Co., Ltd.): positive electrode active material: lithium cobalt oxide (LiCoO₂), D50: 7.2 specific surface area: 0.46 m²/g, hereinafter abbreviated as LCO.

### <Binder>

KF Polymer W #1100 (product name, manufactured by Kureha Corporation): polyvinylidene fluoride, average molecular weight: 280,000, hereinafter abbreviated as PVDF.

Various evaluations in Examples and Comparative Examples were performed using the following methods.

### <Viscosity of Dispersion, Storage Stability of Dispersion>

As the viscosity of the conductive material dispersion prepared using the method described in Example 1, a numerical value after 60 seconds measured when rotated at a speed of 60 rpm at ° C. using a B-type viscometer (TVB-10: Product name, manufactured by Toki Sangyo Co., Ltd.) is used.

Further, for the storage stability of the dispersion, the viscosity of each dispersion after standing at 25° C. for 1 week was measured and a degree of change with respect to the initial viscosity of the each dispersion was evaluated according to the following criteria.

∘: The absolute value of the change with respect to the initial viscosity is 10% or less.

Δ: The absolute value of the change with respect to the initial viscosity exceeds 10% and is 15% or less.

x: The absolute value of the change with respect to the initial viscosity exceeds 15%.

### <Storage Stability of Electrode Paste>

16.45 parts by mass of LCO, 3.22 parts by mass of a PVDF solution (PVDF: 0.48 parts by mass), 2.63 parts by mass of the conductive material dispersion obtained in Examples and Comparative Examples, and 2.70 parts by mass of N-methyl-2-pyrrolidone were charged in a plastic container, and the mixture was kneaded using an Awatori Mixer (product name, manufactured by Thinky Co., Ltd.) to obtain an electrode paste. The polyvinyl acetal resin and the cellulose resin contained in the conductive material dispersion were regarded as binder ingredients, and an amount including the added PVDF was taken as a total binder amount.

The viscosity of the obtained electrode paste was measured using a rheometer under the following conditions.

Device: HAAKE MARSIII (manufactured by Thermo Fisher Scientific Co., Ltd.)

Sensor: Cone C35/1°

Measurement Temperature: 25° C.

Share rate: 10 s⁻¹

Measurement Time: 60 seconds

Further, yor the storage stability of the electrode paste, the viscosity of each electrode paste after standing at 25° C. for one week was measured and a degree of change with respect to the initial viscosity of the each electrode paste was evaluated according to the following criteria. When the viscosity of the electrode paste after one week was measured, in order to eliminate sedimentation, the electrode paste was mixed in advance with an Awatori Mixer at 2,000 rpm for 20 seconds.

⊚: The absolute value of the change with respect to the initial viscosity is 10% or less.

∘: The absolute value of the change with respect to the initial viscosity exceeds 10% and is 15% or less.

Δ: The absolute value of the change with respect to the initial viscosity exceeds 15% and is 20% or less.

x: The absolute value of the change with respect to the initial viscosity exceeds 20%.

### Example 1

As the dispersion medium, 78.4 parts by mass of N-methyl-2-pyrrolidone, 1.12 parts by mass of MC, and 0.48 parts by mass of BL-1 are charged in a plastic bottle, and are mixed and dissolved. After that, 20 parts by mass of Li-435 was charged and dispersed with a paint shaker using zirconia beads as media for 6 hours to obtain a conductive material dispersion. For the obtained dispersion, the “viscosity of the dispersion,” the “storage stability of the dispersion,” and the “storage stability of the electrode paste” were determined using the methods described above. The results are shown in Table 1.

### Examples 2-10, Comparative Examples 1-11

A conductive material dispersion was obtained in the same manner as in Example 1 except that the composition shown in Table 1 (polyvinyl acetal resin type, mixing ratio) was changed. Various measurements for the obtained conductive material dispersion were also performed in the same manner. The results are shown in Table 1.

TABLE 1

| | Composition | | | | | | | | | |
|---|---|---|---|---|---|---|---|---|---|---|
| | | Poly- | Mixing ratio | | Evaluation | | | | | |
| | | vinyl | | Poly- | Conductive material dispersion | | | Electrode slurry | | |
| | | acetal | | vinyl | Initial | | | Initial | | |
| | Cellulose | resin | Cellulose | acetal | viscosity | Change | Storage | viscosity | Change | Storage |
| | resin type | type | resin | resin | (mPa · s) | rate | stability | (mPa · s) | rate | stability |
| Example 1 | MC | BL-1 | 100 | 43 | 1825 | 8% | ◯ | 1706 | −8% | ⊚ |
| Example 2 | MC | BL-10 | 100 | 43 | 1415 | 13% | Δ | 1535 | −5% | ⊚ |
| Example 3 | MC | BX-L | 100 | 43 | 1472 | 6% | ◯ | 1594 | −4% | ⊚ |
| Example 4 | MC | B16H | 100 | 43 | 1755 | 10% | Δ | 1602 | −10% | ◯ |
| Example 5 | MC | B20H | 100 | 43 | 1629 | 9% | ◯ | 1959 | −16% | Δ |
| Example 6 | MC | BL-1 | 100 | 100 | 1168 | 10% | Δ | 1635 | −12% | ◯ |
| Example 7 | MC | BL-10 | 100 | 100 | 1416 | 3% | ◯ | 1959 | −16% | Δ |
| Example 8 | MC | BX-L | 100 | 100 | 1697 | 1% | ◯ | 1724 | −16% | Δ |
| Example 9 | MC | B16H | 100 | 100 | 1434 | 10% | Δ | 1510 | −14% | ◯ |
| Example 10 | MC | B20H | 100 | 100 | 1484 | 7% | ◯ | 1394 | −14% | ◯ |
| Comparative | MC | — | 100 | — | 2910 | 46% | X | 2672 | −33% | X |
| Example 1 | | | | | | | | | | |
| Comparative | — | BL-1 | — | 100 | 3220 | −16% | Δ | 1587 | −18% | Δ |
| Example 2 | | | | | | | | | | |
| Comparative | — | BL-10 | — | 100 | 3460 | −3% | ◯ | 1567 | −15% | Δ |
| Example 3 | | | | | | | | | | |
| Comparative | — | BX-L | — | 100 | 4980 | −6% | ◯ | 1673 | −19% | Δ |
| Example 4 | | | | | | | | | | |
| Comparative | — | B16H | — | 100 | 3340 | −1% | ◯ | 1345 | −24% | X |
| Example 5 | | | | | | | | | | |
| Comparative | — | B20H | — | 100 | 3970 | −11% | Δ | 1562 | −14% | ◯ |
| Example 6 | | | | | | | | | | |
| Comparative | MC | BL-1 | 100 | 233 | 3300 | −10% | Δ | 1546 | −14% | ◯ |
| Example 7 | | | | | | | | | | |
| Comparative | MC | BL-10 | 100 | 233 | 4190 | −6% | ◯ | 1619 | −12% | ◯ |
| Example 8 | | | | | | | | | | |
| Comparative | MC | BX-L | 100 | 233 | 2940 | −6% | ◯ | 1562 | −24% | X |
| Example 9 | | | | | | | | | | |
| Comparative | MC | B16H | 100 | 233 | 4090 | −8% | ◯ | 1493 | −12% | ◯ |
| Example 10 | | | | | | | | | | |
| Comparative | MC | B20H | 100 | 233 | 2720 | −10% | Δ | 1469 | −16% | Δ |
| Example 11 | | | | | | | | | | |

From the results shown in Table 1, the conductive material dispersions of Examples 1-10 containing the polyvinyl acetal resin and the cellulose resin have initial viscosities of 2,000 mPa s or less. In particular, for the storage stabilities of the electrode pastes in Examples 1-3, the absolute values of the changes with respect to the initial viscosities are 10% or less, which are the lowest changes.

In Comparative Examples 1-6 in which only one of the polyvinyl acetal resin and the cellulose resin is contained and in Comparative Examples 7-11 in which the mixing ratio of the polyvinyl acetal resin and the cellulose resin is out of the range of the present invention, the initial viscosities of the conductive material dispersions exceed 2,000 mPa·s, which significantly impairs the handleability. In this way, it can be seen that the conductive material dispersion of the present invention is superior as compared to that in the comparative examples in terms of both the initial viscosity and the storage stability, and is also highly effective in improving the storage stability of the electrode paste.

### INDUSTRIAL APPLICABILITY

As described above, it can be seen that, according to the present invention, it is possible to provide a conductive material dispersion having excellent performance and methods for manufacturing a positive electrode for a lithium ion secondary battery and a lithium ion secondary battery using the conductive material dispersion.

1. A conductive material dispersion containing at least a conductive material, a dispersion medium, a poly vinyl acetal-based resin and a cellulose-based resin, wherein 10-200 parts by weight of the polyvinyl acetal-based resin is contained with respect to 100 parts by weight of the cellulose-based resin.

2. The conductive material dispersion according to claim 1, wherein the conductive material is carbon black having a primary particle size of 30 nm or less and a DBP oil absorption of 160-250 ml/(100 g).

3. The conductive material dispersion according to claim 1, wherein the polyvinyl acetal-based resin has an average polymerization degree of 100-600.

4. The conductive material dispersion according to claim 1, wherein the cellulose-based resin has a weight average molecular weight of 5.000-50,000.

5. A method for manufacturing a positive electrode for a lithium ion secondary battery, comprising: mixing the conductive material dispersion according to claim 1, an electrode active material, and a binder; applying the mixture to an electrode substrate, and drying the mixture.

6. A method for manufacturing a lithium ion secondary battery comprising: mixing the conductive material dispersion according to claim 1, an electrode active material, and a binder; applying the mixture to an electrode substrate: drying the mixture; and incorporating the resulting product as a positive electrode.
